(19) United States
(12) Patent Application Publication
(10) Pub. No.: US 2011/0071902 A1
(43) Pub. Date: Mar. 24, 2011

(54) METHOD, SYSTEM, AND DEVICE FOR SELECTING ADVERTISEMENT CONTENTS

(75) Inventors: Yinyan Tan, Shenzhen (CN); Gang Shao, Shenzhen (CN); Pei Fu, Shenzhen (CN); Daqi Ren, Shenzhen (CN)

(73) Assignee: Huawei Technologies Co., Ltd.

(21) Appl. No.: 12/957,134

(22) Filed: Nov. 30, 2010

Related U.S. Application Data
(63) Continuation of application No. PCT/CN2008/073158, filed on Nov. 21, 2008.

(30) Foreign Application Priority Data
May 31, 2008 (CN) 200810109870.7

(51) Int. Cl. G06Q 30/00

(52) U.S. Cl. 705/14.49

(57) ABSTRACT

A method, system, and device for selecting advertisement contents are provided. The method for selecting advertisement contents includes: receiving an advertisement request carrying advertisement request parameters; matching the advertisement request parameters with advertisement description information including a version field; and returning the matched advertisement description information, the matched version field in the advertisement description information, and an advertisement content corresponding to the matched advertisement description information. An advertisement includes multiple versions of advertisement description information, which enhances the flexibility in advertisement description and increases the opportunity of selecting and presenting the advertisement to users, thereby maximizing the benefit of the advertiser, saving the storage space, and reducing the amount of data transmission.

### CROSS-REFERENCE TO RELATED APPLICATIONS

This application is a continuation of International Application No. PCT/CN2008/073158, filed on Nov. 21, 2008, which claims priority to Chinese Patent Application No. 200810109870.7, filed on May 31, 2008, both of which are hereby incorporated by reference in their entireties.

### TECHNICAL FIELD

The present invention relates to the field of communications technology, and more particularly to a method, system, and device for selecting advertisement contents.

### BACKGROUND

Advertisement is a means of communication for transferring information to the public openly and widely through a specific form of media at certain costs for a specific demand. According to different expression modes, advertisements may be categorized into text or picture advertisements, audio advertisements, and video advertisements. Due to characteristics of large information quantity, expressiveness, and easy interaction with users, video advertisements can improve the image of advertised products and increase added value and pleasant experience for the audience, thereby winning favor of advertisers and the audience.

However, the costs of producing, storing, and transmitting video advertisements are higher than those of plain advertisements such as text or picture advertisements. The length of time of video advertisements is one factor to be considered by advertisers, because the charging of the video advertisements is related to the length of time.

Advertisers hope to achieve the best advertising effect with the least expenditure. Therefore, many advertisers develop multiple versions of contents for one advertisement of a product or service thereof and distribute the contents according to actual situations. Taking KFC's advertising of a new plated meal as an example, in the early stage of promoting the meal, in order to impress customers with the new plated meal, the advertisement is detailed in content and lasts for a long time, resulting in high expenses; but in the middle stage, a condensed advertisement is used to reduce the expenses for consolidating the effect. In this case, multiple advertisement contents with independence there-between need to be developed.

The prior art at least has the following problems.

In the prior art, one advertisement corresponds to one advertisement description and thus can only satisfy an advertisement request of one condition. As a result, the advertisement has a small possibility of being selected and flexibility is low. Moreover, to distribute advertisements of one theme, an advertiser needs to produce multiple advertisement contents with multiple pieces of advertisement description information attached thereto. In this manner, multiple advertisements of one theme are independent from user requested advertisements and advertisement transmission, and thus the multiple advertisements of one theme requires unnecessary advertisement storage and transmission traffic.

### SUMMARY

The present invention is directed to a method, system, and device for selecting advertisement contents, to achieve the purpose of presenting different advertisement contents to users through one advertisement content and multiple pieces of advertisement description information about the advertisement content, so as to store the storage space and decrease the transmission traffic of advertisements.

In order to achieve the above objective, an embodiment of the present invention provides a method for selecting advertisement contents. The method includes: receiving an advertisement request carrying advertisement request parameters; matching the advertisement request parameters with advertisement description information including a version field; and returning matched advertisement description information, a matched version field in the advertisement description information, and an advertisement content corresponding to the matched advertisement description information.

An embodiment of the present invention further provides a system for selecting advertisement contents, which includes a service server and an advertisement server.

The service server is configured to send an advertisement request carrying advertisement request parameters.

The advertisement server is configured to receive the advertisement request sent by the service server, match the advertisement request parameters carried in the advertisement request with advertisement description information including a version field that is stored in the advertisement server, and return matched advertisement description information, a matched version field in the advertisement description information, and an advertisement content corresponding to the matched advertisement description information to the service server, so that the service server presents the advertisement content according to the matched version field in the advertisement description information when providing an online service.

An embodiment of the present invention further provides a system for selecting advertisement contents, which includes a service client and an advertisement client.

The service client is configured to send an advertisement request carrying advertisement request parameters.

The advertisement client is configured to receive the advertisement request sent by the service client, match the advertisement request parameters carried in the advertisement request with advertisement description information stored in the advertisement client, and return matched advertisement description information, a matched version field in the advertisement description information, and an advertisement content corresponding to the matched advertisement description information to the service client when the advertisement client contains the advertisement description information matching with the advertisement request parameters, so that the service client presents the advertisement content according to the matched version field in the advertisement description information.

An embodiment of the present invention further provides an advertisement server, which includes: a receiving module, configured to receive an advertisement request carrying an advertisement request parameters; an advertisement description library, configured to store advertisement contents and advertisement description information including a version field; an advertisement selection module, configured to match the advertisement request parameters carried in the advertisement request that is received by the receiving module with the advertisement description information stored in the advertisement description library; and a return module, configured to return the advertisement description information matched by the advertisement selection module, the matched version field in the advertisement description information, and the advertisement content corresponding to the matched advertisement description information to a service server or an advertisement client.

An embodiment of the present invention further provides an advertisement client, which includes: a request receiving module, configured to receive an advertisement request carrying an advertisement request parameters that is sent by a service client; an advertisement description library, configured to store advertisement description information including a version field and/or advertisement contents; an advertisement selection module, configured to match the advertisement request parameters carried in the advertisement request that is received by the request receiving module with the advertisement description information stored in the advertisement description library; and a content return module, configured to return the matched advertisement description information, the matched version field in the advertisement description information, and the advertisement content corresponding to the matched advertisement description information to the service client when the advertisement selection module selects the advertisement description information matching with the advertisement request parameters.

Through the embodiments of the present invention, the advertisement server or advertisement client receives an advertisement request, matches advertisement request parameters carried in the advertisement request with stored advertisement description information, and then returns matched advertisement description information and an advertisement content corresponding to the matched advertisement description information to the service client or service server. In the embodiments of the present invention, one advertisement may include multiple versions of advertisement description information, which enhances the flexibility in advertisement description and increases the opportunity of selecting and presenting an advertisement to users, thereby maximizing the benefit for an advertiser, saving the storage space, and reducing the amount of transmitted data.

### BRIEF DESCRIPTION OF THE DRAWINGS

FIG. 1 is a schematic diagram of advertisement description information proposed in an embodiment of the present invention;

FIG. 2 is a structural view of a system for selecting advertisement contents in a first embodiment of the present invention;

FIG. 3 is a structural view of a system for selecting advertisement contents in a second embodiment of the present invention;

FIG. 4 is a structural view of a system for selecting advertisement contents in a third embodiment of the present invention;

FIG. 5 is a structural view of a system for selecting advertisement contents in a fourth embodiment of the present invention;

FIG. 6 is a structural view of an advertisement server in an embodiment of the present invention;

FIG. 7 is a structural view of an advertisement client in an embodiment of the present invention;

FIG. 8 is a flow chart of a method for selecting advertisement contents in an embodiment of the present invention;

FIG. 9 is a flow chart illustrating initiation of an advertisement request and provision of an online service by a service server in the first embodiment of the present invention;

FIG. 10 is a flow chart illustrating initiation of an advertisement request and provision of an offline service by the service server in the first embodiment of the present invention; and

FIG. 11 is a flow chart illustrating initiation of an advertisement request by a service client in the second embodiment of the present invention.

### DETAILED DESCRIPTION

In the embodiments of the present invention, a method for selecting advertisement contents is provided, which achieves the following purpose: when an advertiser distributes advertisements for a product or service of the same theme, to present different advertisement contents to users, the advertiser needs to provide only one advertisement content and multiple pieces of advertisement description information about the advertisement content. This stores the storage space and decreases the transmission traffic of advertisements.

In the embodiments of the present invention, the description of a version field description is added to the advertisement description information. One original advertisement content may have one or more versions of descriptions, which indicates that one original advertisement content corresponds to one or more versions of an advertisement. For example, through a version field in advertisement description information, one full advertisement or multiple condensed advertisements at different degrees may be extracted from an original advertisement content.

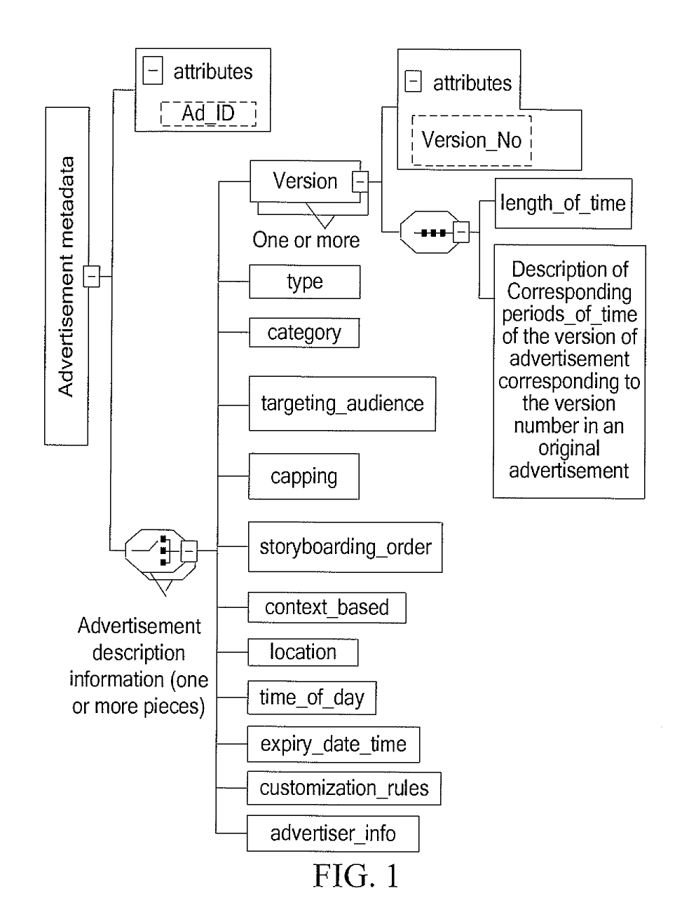

FIG. 1 is a schematic structural view of advertisement description information in an embodiment of the present invention. The advertisement description information in the embodiment of the present invention includes an attributes field containing an advertisement identifier (Ad_ID). The advertisement data structure in the embodiment of the present invention further includes one or more pieces of advertisement description information. Each piece of advertisement description information includes the following fields: version, type, category, targeting_audience, capping, storyboarding_order, context_based, locationd, time_of_day, expiry_date_time, customization_rules, and advertiser_info. Each piece of advertisement description information may include one or more version fields.

For advertisement description information of a video advertisement, a version field includes the following information: a version number (version_no), a length of time (length_of_time) of a version of the advertisement corresponding to the version number, and corresponding periods of time (periods_of_time) in the version of the advertisement corresponding to the version number in an original advertisement. Presenting aversion of the advertisement is to present the contents corresponding to the present periods of time specified by periods_of_time (each period of time includes a start time and an end time).

Advertisement description information of an audio advertisement is similar to that of the video advertisement, and a version field thereof is similar to that of the video advertisement.

For advertisement description information of a text or picture advertisement, the specific description of a version field is slightly different from that of the video/audio advertisement. Aversion field in a text advertisement includes a content length of the text advertisement and a corresponding segment/position of this version of the text advertisement in an original advertisement. A version field in a picture advertisement includes a size of the picture advertisement and a corresponding position of this version of the picture advertisement in an original advertisement or a scale of this version of the picture advertisement relative to the original advertisement.

The eXtensible Markup Language Schema Document (XSD) of version fields of different types of advertisements is represented as follows.

(1) Description of a version field of a video/audio advertisement:

<xs:element name=“Version” maxOccurs=“unbounded”>

<xs:complexType>

<xs:sequence>

<xs:element name=“length_of_time” type=“xs:float” />
<xs:element name=“periods_of_time” />

<xs:complexType>

<xs:sequence maxOccurs=“unbounded”>

<xs:element name=“begin_time”
type=“xs:time” />
<xs:element name=“end_time”
type=“xs:time” />

</xs:sequence>

</xs:complexType>

</xs:sequence>
<xs:attribute name= “Version_No”/>

</xs:complexType>

</xs:element>

(2) Description of a version field of a text advertisement:

<xs:element name=“Version” maxOccurs=“unbounded”>

<xs:complexType>

<xs:sequence>

<xs:element name= “length_of_words”/>
<xs:element name=“periods_of_words”/>

<xs:complexType>

<xs:sequence maxOccurs=“unbounded”>

<xs:element name=“begin_No” type=
“xs:positiveInteger”/>
<xs:element name=“end_No” type=
“xs:positiveInteger”/>

</xs:sequence>

</xs:complexType>

</xs:sequence>
<xs:attribute name=“Version_No”/>

</xs:complexType>

</xs:element>

(3) One description of a version field of a picture advertisement:

<xs:element name=“Version” maxOccurs=“unbounded”>

<xs:complexType>

<xs:sequence>

<xs:element name=“size_of_pic”/>
<xs:element name=“ position_of_pic”/>

<xs:complexType>

<xs:element name=“begin_ position”/>

//coordinate in the upper left corner

<xs:elementname=“end_position”/> //coordinate

in the lower right corner

</xs:sequence>

</xs:complexType>

</xs:sequence>
<xs:attribute name=“Version_No”/>

</xs:complexType>

</xs:element>

(4) Another description of a version field of a picture advertisement:

<xs:element name=“Version” maxOccurs=“unbounded”>

<xs:complexType>

<xs:sequence>

<xs:element name=“size_of_pic”/>
<xs:element name=“ scale_of_pic” type=“xs:float”/>
//scale

</xs:sequence>
<xs:attribute name=“Version_No”/>

</xs:complexType>

</xs:element>

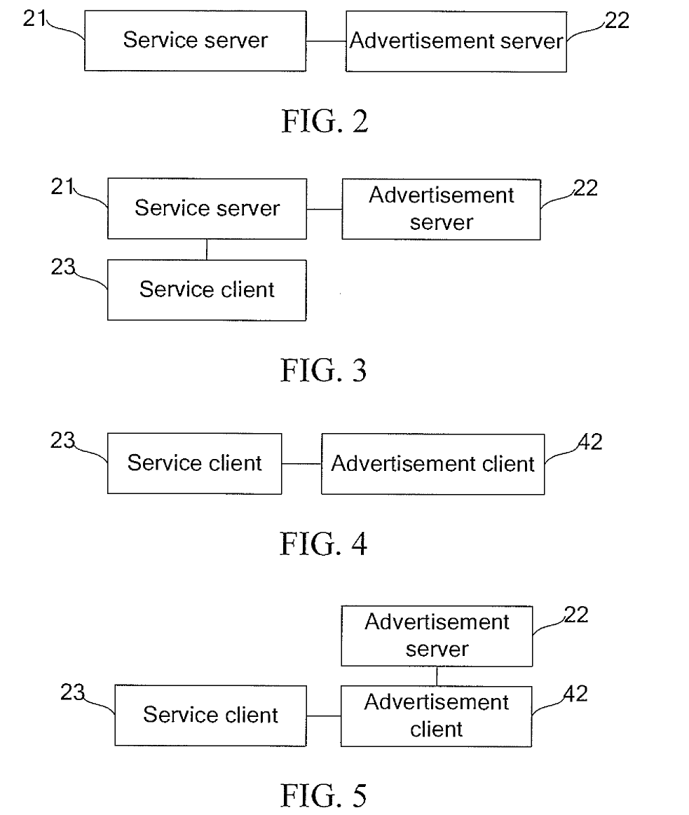

FIG. 2 is a structural view of a system for selecting advertisement contents in a first embodiment of the present invention, which includes a service server 21 and an advertisement server 22.

The service server 21 is configured to send an advertisement request carrying advertisement request parameters. The advertisement request parameters carried in the advertisement request may include one or more of the following: a user ID/application ID, the number of requested advertisements, an advertisement feature, and an application context. When the service server 21 provides an online service, after receiving advertisement description information matching with the advertisement request parameters, a matched version field in the advertisement description information, and an advertisement content corresponding to the matched advertisement description information, the service server 21 presents the advertisement content according to the matched version field in the advertisement description information.

The advertisement server 22 is configured to receive the advertisement request sent by the service server 21, match the advertisement request parameters carried in the advertisement request with advertisement description information including a version field that is stored in the advertisement server 22, and return the matched advertisement description information, the matched version field in the advertisement description information, and the advertisement content corresponding to the matched advertisement description information to the service server 21. The matched version field includes a length of time of a matched version of advertisement and corresponding periods of time of the matched version of advertisement in an original advertisement.

In a second embodiment of the present invention, as shown in FIG. 3, the system for selecting advertisement contents further includes a service client 23.

The service client 23 is configured to receive the matched advertisement description information, the matched version field in the advertisement description information, and the advertisement content corresponding to the matched advertisement description information that are sent by the service server 21, and present the advertisement content according to the matched version field in the advertisement description information when the service server 21 provides an offline service.

FIG. 4 is a structural view of a system for selecting advertisement contents in a third embodiment of the present invention, which includes a service client 23 and an advertisement client 42.

The service client 23 is configured to send an advertisement request carrying advertisement request parameters, and after receiving advertisement description information matching with the advertisement request parameters, a matched version field in the advertisement description information, and an advertisement content corresponding to the matched advertisement description information, present the advertisement content according to the matched version field in the advertisement description information.

The advertisement client 42 is configured to receive the advertisement request sent by the service client 23, match the advertisement request parameters carried in the advertisement request with advertisement description information stored in the advertisement client 42, and return the matched advertisement description information, the matched version field in the advertisement description information, and the advertisement content corresponding to the matched advertisement description information to the service client 23 when the advertisement client 42 contains the advertisement description information matching with the advertisement request parameters.

In a fourth embodiment of the present invention, as shown in FIG. 5, the system for selecting advertisement contents further includes an advertisement server 22.

The advertisement server 22 is configured to receive the advertisement request sent by the advertisement client 42, and return the matched advertisement description information, the matched version field in the advertisement description information, and the advertisement content corresponding to the matched advertisement description information to the advertisement client 42 when the advertisement client 42 does not contain the advertisement description information matching with the advertisement request parameters. The advertisement client 42 stores the matched advertisement description information and the advertisement content corresponding to the matched advertisement description information, and returns the matched advertisement description information, the matched version field in the advertisement description information, and the advertisement content corresponding to the matched advertisement description information that are returned by the advertisement server 22 to the service client 23.

In the above advertisement content selection system, the service server 21 and the service client 23 are both service components. The service component is a component for bearing advertisements, which presents the advertisements to users through the service provided thereby.

The advertisement server 22 and the advertisement client 42 are both advertisement components. In advertisement selection, the advertisement component matches an advertisement request with multiple versions of advertisement description information of an advertisement. As long as any version of advertisement description information matches with the advertisement request, the advertisement component returns matched advertisement description information, a matched version field in the advertisement description information, and an advertisement content corresponding to the matched advertisement description information to the service component.

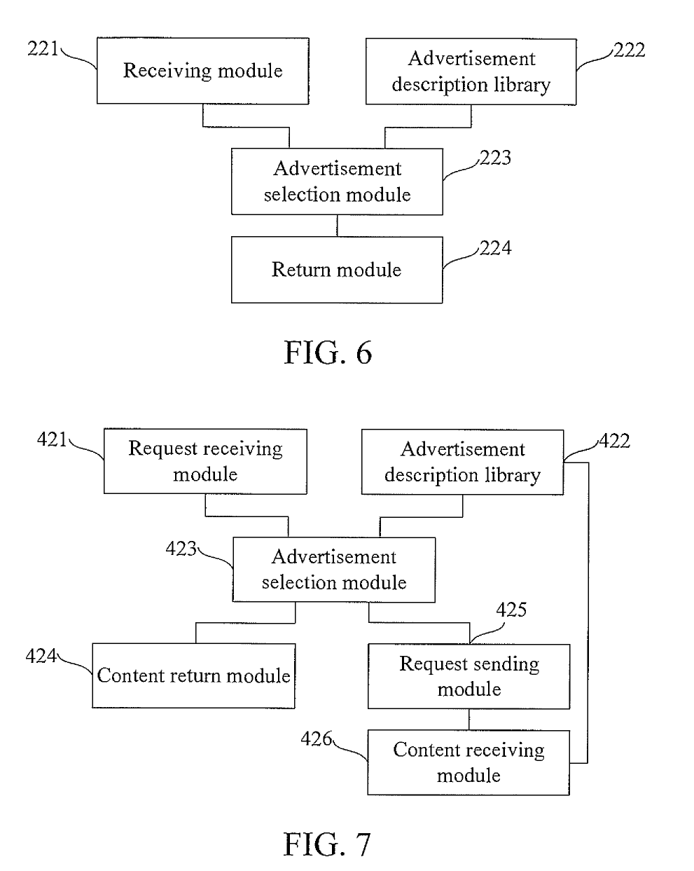

FIG. 6 is a structural view of an advertisement server in an embodiment of the present invention. The advertisement server includes a receiving module 221, an advertisement description library 222, an advertisement selection module 223, and a return module 224.

The receiving module 221 is configured to receive an advertisement request carrying advertisement request parameters.

The advertisement description library 222 is configured to store advertisement contents and various versions of advertisement description information including a version field.

The advertisement selection module 223 is configured to match the advertisement request parameters carried in the advertisement request that is received by the receiving module 221 with the advertisement description information stored in the advertisement description library 222.

The return module 224 is configured to return the advertisement description information matched by the advertisement selection module 223, the matched version field in the advertisement description information, and the advertisement content corresponding to the matched advertisement description information to a service server 21 or an advertisement client 42.

FIG. 7 is a structural view of an advertisement client in an embodiment of the present invention. The advertisement client includes a request receiving module 421, an advertisement description library 422, an advertisement selection module 423, and a content return module 424.

The request receiving module 421 is configured to receive an advertisement request carrying advertisement request parameters that is sent by a service client 23.

The advertisement description library 422 is configured to store advertisement contents and advertisement description information including a version field.

The advertisement selection module 423 is configured to match the advertisement request parameters carried in the advertisement request that is received by the request receiving module 421 with the advertisement description information stored in the advertisement description library 422.

The content return module 424 is configured to return the matched advertisement description information, the matched version field in the advertisement description information, and the advertisement content corresponding to the matched advertisement description information to the service client 23 when the advertisement selection module 423 selects the advertisement description information matching with the advertisement request parameters.

The advertisement client 42 further includes a request sending module 425 and a content receiving module 426.

The request sending module 425 is configured to send the advertisement request to an advertisement server 22 when the advertisement selection module 423 does not obtain by selection the advertisement description information matching with the advertisement request parameters.

The content receiving module 426 is configured to receive matched advertisement description information, a matched version field in the advertisement description information, and an advertisement content corresponding to the matched advertisement description information that are returned by the advertisement server 22, store the matched advertisement description information and the advertisement content corresponding to the matched advertisement description information in the advertisement description library 422, and meanwhile notify the content return module 424 of returning the matched advertisement description information, the matched version field in the advertisement description information, and the advertisement content corresponding to the matched advertisement description information to the service client 23.

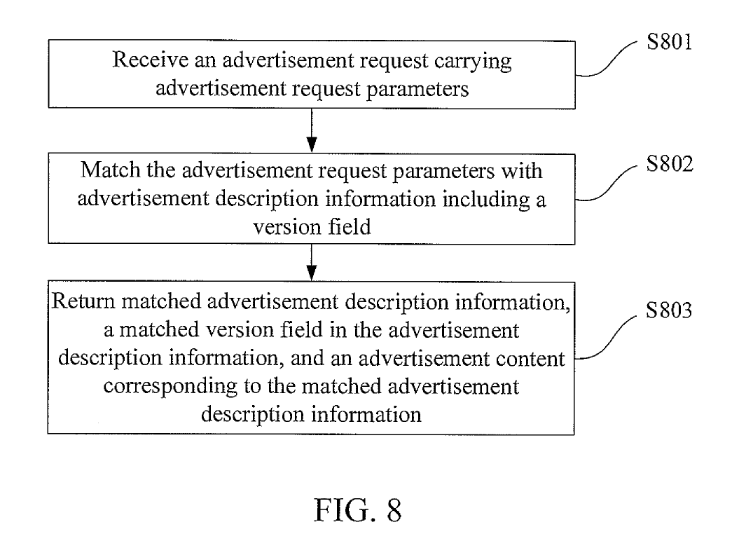

FIG. 8 is a flow chart of a method for selecting advertisement contents in an embodiment of the present invention. The method includes the following steps.

In step S801, an advertisement request carrying advertisement request parameters is received. The advertisement request parameters may include one or more of the following: a user ID/application ID, the number of requested advertisements, an advertisement feature, and an application context.

In step S802, the advertisement request parameters match with advertisement description information including a version field.

When the advertisement request requests a video/audio advertisement, the version field in the advertisement description information includes a version number, a length of time of a version of advertisement corresponding to the version number, and corresponding periods of time in the version of advertisement corresponding to the version number in an original advertisement.

When the advertisement request requests a picture advertisement, the version field in the advertisement description information includes a content size of the picture advertisement, a version number, and a corresponding position of a version of the picture advertisement corresponding to the version number in an original advertisement or a scale of the version of picture advertisement corresponding to the version number relative to the original advertisement.

When the advertisement request requests a text advertisement, the version field in the advertisement description information includes a content length of the text advertisement, a version number, and a corresponding segment or position of aversion of text advertisement corresponding to the version number in an original advertisement.

In step S803, matched advertisement description information, a matched version field in the advertisement description information, and an advertisement content corresponding to the matched advertisement description information are returned.

After receiving the matched advertisement description information, the matched version field in the advertisement description information, and the advertisement content corresponding to the matched advertisement description information, a service server 21 or service client 23 presents the returned advertisement content according to the matched version field in the advertisement description information.

When the service client 23 sends an advertisement request, an advertisement client 42 receives the advertisement request sent by the service client 23 and matches advertisement request parameters carried in the advertisement request with advertisement description information stored in the advertisement client 42.

When the advertisement client 42 contains the advertisement description information matching with the advertisement request parameters, the advertisement client 42 returns the matched advertisement description information, the matched version field in the advertisement description information, and the advertisement content corresponding to the matched advertisement description information to the service client 23.

When the advertisement client 42 does not contain the advertisement description information matching with the advertisement request parameters, the advertisement client 42 sends the advertisement request to an advertisement server 22, receives and stores matched advertisement description information, a matched version field in the advertisement description information, and an advertisement content corresponding to the matched advertisement description information that are returned by the advertisement server 22, and meanwhile returns the matched advertisement description information, the matched version field in the advertisement description information, and the advertisement content corresponding to the matched advertisement description information that are returned by the advertisement server 22 to the service client 23.

In the first embodiment of the present invention, the process in which the service server 21 initiates an advertisement request is described. The service server 21 initiates an advertisement request to the advertisement server 22. The advertisement server 22 returns matched advertisement description information and an advertisement content corresponding to the matched advertisement description information to the service server 21. For an online service provided by the service server 21 in real time, the service server 21 presents the advertisement content corresponding to the advertisement description information. For an offline service not requiring support of the network side in advertisement content presenting, the service server 21 returns both advertisement description information and an advertisement content corresponding to the matched advertisement description information to the service client 23 in the presenting of the advertisement content, and the service client 23 presents the advertisement content corresponding to the advertisement description information.

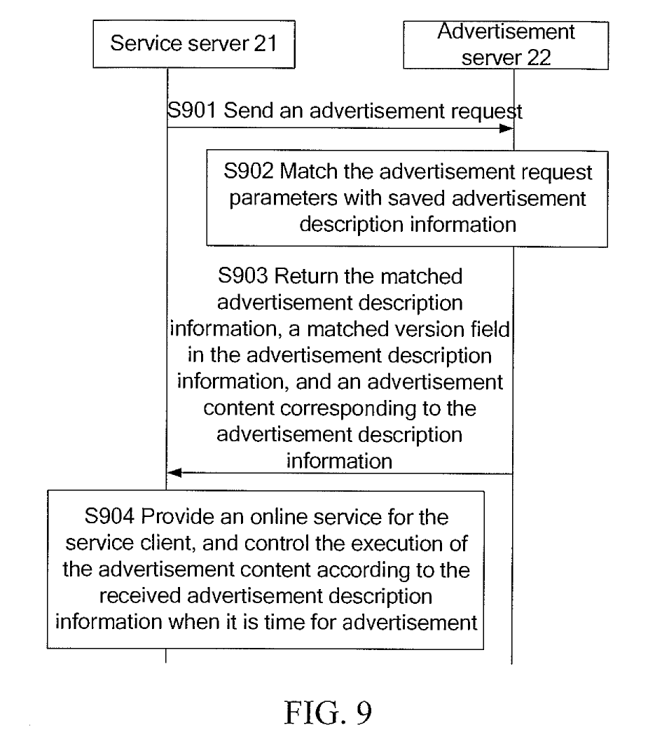

FIG. 9 is a flow chart illustrating provision of an online service and initiation of an advertisement request by the service server in the first embodiment of the present invention, which specifically includes the following steps.

In step S901, the service server 21 sends an advertisement request to the advertisement server 22. Advertisement request parameters carried in the advertisement request may include one or more of the following: a user ID/application ID, the number of requested advertisements, an advertisement feature, and an application context.

In step S902, the advertisement server 22 matches the advertisement request parameters with advertisement description information stored in the advertisement server 22. If a version of advertisement description information of an advertisement matches with the advertisement request parameters carried in the advertisement request, step S903 is performed; if no advertisement description information matches with the advertisement request parameters carried in the advertisement request, the advertisement server 22 returns information indicating that no matched advertisement description information is found to the service server 21.

In step S903, the advertisement server 22 returns the matched advertisement description information, a matched version field in the advertisement description information, and an advertisement content corresponding to the matched advertisement description information to the service server 21.

In step S904, when providing an online service for the service client 23, the service server 21 controls the presenting of the advertisement content according to the received advertisement description information when it is time for advertisement.

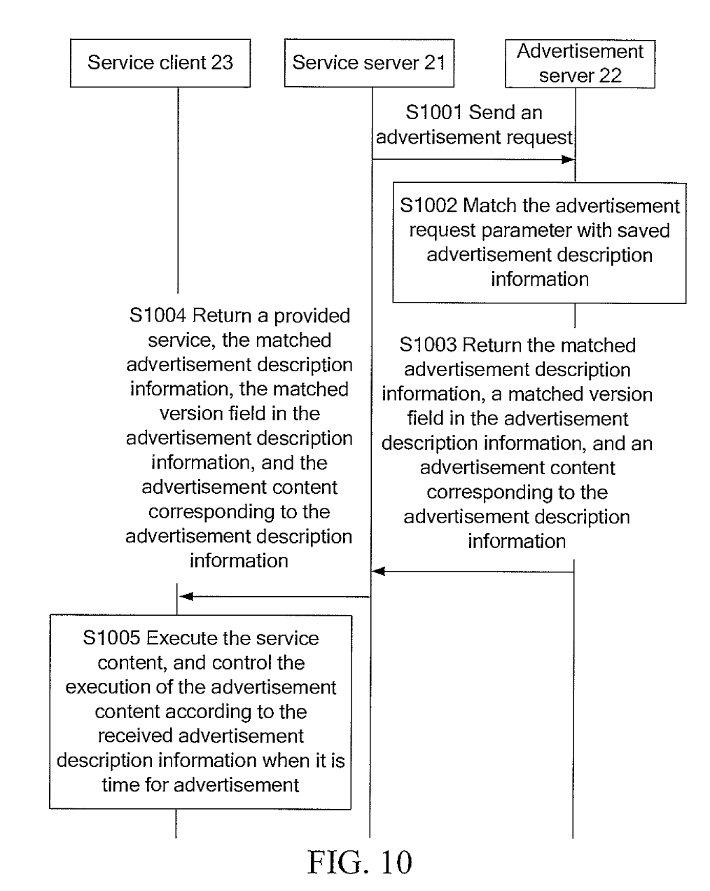

FIG. 10 is a flow chart illustrating provision of an offline service and initiation of an advertisement request by the service server in the first embodiment of the present invention, which specifically includes the following steps.

In step S1001, the service server 21 sends an advertisement request to the advertisement server 22. Advertisement request parameters carried in the advertisement request may include one or more of the following: a user ID/application ID, the number of requested advertisements, an advertisement feature, and an application context.

In step S1002, the advertisement server 22 matches the advertisement request parameters with advertisement description information stored in the advertisement server 22. If a version of advertisement description information of an advertisement matches with the advertisement request parameters carried in the advertisement request, step S1003 is performed; if no advertisement description information matches with the advertisement request parameters carried in the advertisement request, the advertisement server 22 returns information indicating that no matched advertisement description information is found to the service server 21.

In step S1003, the advertisement server 22 returns the matched advertisement description information, a matched version field in the advertisement description information, and an advertisement content corresponding to the matched advertisement description information to the service server 21.

In step S1004, when providing an offline service for the service client 23, the service server 21 returns a service content provided by the service server 21, the matched advertisement description information, the matched version field in the advertisement description information, and the advertisement content corresponding to the matched advertisement description information to the service client 23.

In step S1005, the service client 23 presents the service content, and controls the presenting of the advertisement content according to the received advertisement description information when it is time for advertisement.

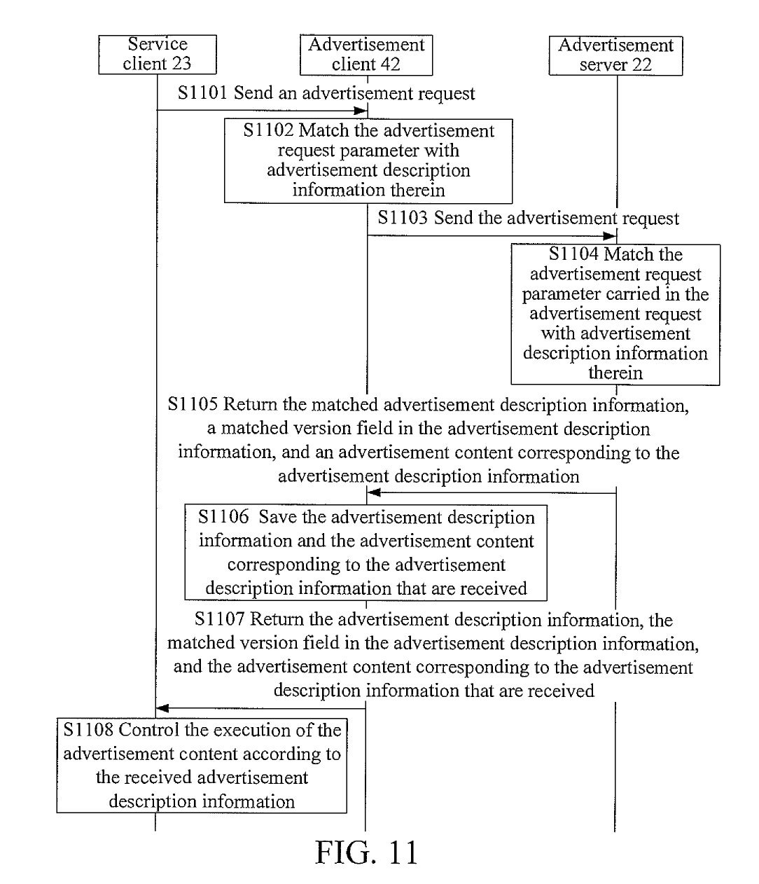

FIG. 11 is a flow chart illustrating initiation of an advertisement request by the service client in the second embodiment of the present invention, which specifically includes the following steps.

In step S1101, the service client 23 sends an advertisement request to the advertisement client 42. Advertisement request parameters carried in the advertisement request may include one or more of the following: a user ID/application ID, the number of requested advertisements, an advertisement feature, and an application context.

In step S1102, the advertisement client 42 receives the advertisement request and matches the advertisement request parameters with advertisement description information in the advertisement client 42. If any matched advertisement description information exists, step S1107 is performed; if any matched advertisement description information does not exist, step S1103 is performed.

In step S1103, the advertisement client 42 sends the advertisement request to the advertisement server 22. The advertisement request parameters carried in the advertisement request may include one or more of the following: a user ID/application ID, the number of requested advertisements, an advertisement feature, and an application context.

In step S1104, the advertisement server 22 receives the advertisement request and matches the advertisement request parameters carried in the advertisement request with advertisement description information in the advertisement server 22. If a version of advertisement description information of an advertisement matches with the advertisement request parameters carried in the advertisement request, step S1105 is performed; if no advertisement description information matches with the advertisement request parameters carried in the advertisement request, the advertisement server 22 returns information indicating that no matched advertisement description information is found to the advertisement client 42.

In step S1105, the advertisement server 22 returns the matched advertisement description information, a matched version field in the advertisement description information, and an advertisement content corresponding to the matched advertisement description information to the advertisement client 42.

In step S1106, the advertisement client 42 stores the advertisement description information and the advertisement content corresponding to the matched advertisement description information that are received, for use in the next advertisement selection. This step is optional.

In step S1107, the advertisement client 42 returns the advertisement description information, the matched version field in the advertisement description information, and the advertisement content corresponding to the matched advertisement description information that are received to the service client 23.

In step S1108, the service client 23 controls the presenting of the advertisement content according to the received advertisement description information.

The method for selecting advertisement contents provided in the present invention is further illustrated in detail below with a specific example.

Assume that KFC has launched a new hot wing product and is preparing an advertising campaign. KFC produces by effort a detailed video advertisement lasting for 1 minute, and completes advertisement description information including a version field that allows an advertiser to describe the submitted advertisement content in detail to indicate whether the advertisement can have multiple versions and advertisement description information of each version according to requirements in an advertisement server 22 for the advertisement description information when submitting the advertisement to the advertisement server 22. KFC or the entrusted advertising agency thinks that partial contents extracted from the 1-minute advertisement may also compose a full advertisement expressing the desire of the advertiser according to the analysis of the advertisement content. Therefore, KFC or the entrusted advertising agency describes periods of time (15 seconds-30 seconds and 45 seconds-60 seconds) of the extracted contents in the origial 1-minute video advertisement as periods_of_time in the version field, and thus obtains a condensed advertisement lasting for 30 seconds.

The advertisement description information of the new hot wing product launched by KFC is shown in Table 1.

```
TABLE 1
    Ad_ID: 00001
    Type: video
    Category: fast food
    Targeting audience: 20-30 years old people
    Version: Version 1, length of time: 60 seconds, period of time:
0-60 seconds;
    Version: Version 2, length of time: 30 seconds, periods of time:
15 seconds-30 seconds and 45 seconds-60 seconds
```

When a user watches a video program, a video service client 23 inserts an advertising area at a specified position of the video program. When the program is watched the content corresponding to the specified position, the video service client 23 requests a 60 second fast food video advertisement from an advertisement client 42. Because no advertisement in the advertisement client 42 satisfies the condition, the advertisement client 42 forwards the advertisement request to the advertisement server 22. The advertisement server 22 matches advertisement request parameters carried in the advertisement request with advertisement description information in an advertisement description library 222 and selects the advertisement with Ad_ID of 00001. Then, the advertisement server 22 sends the 1-minute KFC hot wing advertisement content, the advertisement description information shown in Table 1, and the specified Version 1 to the advertisement client. The advertisement client acquires the content, stores the 1-minute KFC hot wing advertisement content and the advertisement description information in the advertisement description library 222 of the advertisement client, and sends the content sent by the advertisement server 22 to the video service client 23. The video service client 23 plays 0-60 seconds of the advertisement content according to the indication of period of time in the advertisement description information.

When the user browses a web page, the advertising area at the right side of the web page requests a 30 s fast food video advertisement. Then, a web page client, that is, the service client 23, sends an advertisement request to the advertisement client 42, and finds the last stored KFC hot wing advertisement in the advertisement client 42 with the matched version being Version 2. The advertisement client 42 directly sends the 60 second advertisement content, the advertisement description information shown in Table 1, and the specified Version 2 to the web page client. The web page client plays 15 seconds-30 seconds and 45 seconds-60 seconds of the advertisement content according to the indication of periods of time in Version 2.

According to the embodiments of the present invention, one advertisement includes multiple versions of advertisement description information, which enhances the flexibility in advertisement description and increases the opportunity of selecting and presenting the advertisement to users. The advertiser can distribute different versions of advertisements reasonably according to strategies and gain the maximum benefit. Through the version parameter description in the version field that is added, one advertisement content actually corresponds to multiple advertisements of the same theme, but the advertiser only needs to provide one advertisement content, and the advertisement component 22 only needs to store one advertisement, too, thereby saving the storage space. When a corresponding version of the original advertisement is selected, the advertisement client 42 stores the version of advertisement. Then, when the service server 21 or service client 23 requests another version of the original advertisement the next time, the advertisement client 42 does not need to request the advertisement from the advertisement server 22 again; instead, the advertisement stored in the advertisement client 42 may be returned to the service server 21 or service client 23 directly, which reduces the data transmission between the advertisement server 22 and the advertisement client 42.

Through the above description of the implementation, it is clear to persons skilled in the art that the present invention may be accomplished through hardware, or through software plus a necessary universal hardware platform. Base on this, the technical solutions of the present invention may be embodied in the form of a software product. The software product may be stored in a nonvolatile storage media (for example, CD-ROM, USB flash drive, or removable hard disk) and contain several instructions configured to instruct computer equipment (for example, a personal computer, a server, or network equipment) to perform the method according to the embodiments of the present invention.

It should be understood by persons skilled in the art that the accompanying drawings are merely schematic diagrams of preferred embodiments, and modules or processes in the accompanying drawings are not necessarily required in implementing the present invention.

It should be understood by persons skilled in the art that, modules in a device according to an embodiment may be distributed in the device of the embodiment according to the description of the embodiment, or be correspondingly changed to be disposed in one or more devices different from this embodiment. The modules of the above embodiment may be combined into one module, or further divided into a plurality of sub-modules.

The sequence numbers of the above embodiments of the present invention are merely for the convenience of description, and do not imply the preference among the embodiments.

Finally, it should be noted that the above embodiments are merely provided for describing the technical solutions of the present invention, but not intended to limit the present invention. It should be understood by persons of ordinary skill in the art that although the present invention has been described in detail with reference to the embodiments, modifications can be made to the technical solutions described in the embodiments, or equivalent replacements can be made to some technical features in the technical solutions, as long as such modifications or replacements do not depart from the spirit and scope of the present invention.

What is claimed is:

1. A method for selecting advertisement contents, the method comprising:
receiving an advertisement request carrying advertisement request parameters;
matching the advertisement request parameters with advertisement description information which comprises a version field; and
returning the matched advertisement description information, the matched version field in the advertisement description information, and an advertisement content corresponding to the matched advertisement description information.

2. The method according to claim 1, further comprising:
presenting the advertisement content according to the matched version field in the advertisement description information.

3. The method according to claim 1, further comprising:
presenting, by a service server, the advertisement content according to the matched version field in the advertisement description information when providing an online service.

4. The method according to claim 1, further comprising:
receiving, by a service client, the matched advertisement description information, the matched version field in the advertisement description information, and the advertisement content corresponding to the matched advertisement description information that are sent by a service server when the service server provides an offline service; and
presenting, by the service client, the advertisement content according to the matched version field in the advertisement description information.

5. The method according to claim 1, wherein when a service client sends the advertisement request, the matching the advertisement request parameters with the advertisement description information comprises:
matching, by an advertisement client, the advertisement request parameters with advertisement description information stored in the advertisement client.

6. The method according to claim 5, wherein the returning the matched advertisement description information, the matched version field in the advertisement description information, and the advertisement content corresponding to the matched advertisement description information comprises:
returning, by the advertisement client, the matched advertisement description information, the matched version field in the advertisement description information, and the advertisement content corresponding to the matched advertisement description information to the service client, when the advertisement client contains the advertisement description information matching with the advertisement request parameters.

7. The method according to claim 5, further comprising: sending, by the advertisement client, the advertisement request to an advertisement server, and receiving and then returning, matched advertisement description information, a matched version field in the advertisement description information, and an advertisement content corresponding to the matched advertisement description information that are returned by the advertisement server, to the service client, when the advertisement client does not contain the advertisement description information matching with the advertisement request parameters, so that the service client presents the advertisement content according to the matched version field in the advertisement description information.

8. The method according to claim 1, wherein when the advertisement request requests a video/audio advertisement, the version field in the advertisement description information comprises a version number, a length of time of a version of advertisement corresponding to the version number, and corresponding periods of time in the version of advertisement corresponding to the version number in an original advertisement.

9. The method according to claim 1, wherein when the advertisement request requests a picture advertisement, the version field in the advertisement description information comprises a content size of the picture advertisement, a version number, and a corresponding position of a version of picture advertisement corresponding to the version number in an original advertisement or a scale of the version of picture advertisement corresponding to the version number relative to the original advertisement.

10. The method according to claim 1, wherein when the advertisement request requests a text advertisement, the version field in the advertisement description information comprises a content length of the text advertisement, a version number, and a corresponding segment or position of a version of the text advertisement corresponding to the version number in an original advertisement.

11. A system for selecting advertisement contents, the system comprising:
a service server, configured to send an advertisement request carrying advertisement request parameters; and
an advertisement server, configured to receive the advertisement request sent by the service server, match the advertisement request parameters carried in the advertisement request with advertisement description information comprising a version field that is stored in the advertisement server, and return the matched advertisement description information, the matched version field in the advertisement description information, and an advertisement content corresponding to the matched advertisement description information to the service server, so that the service server presents the advertisement content according to the matched version field in the advertisement description information when providing an online service.

12. The system according to claim 11, further comprising:
a service client, configured to receive the matched advertisement description information, the matched version field in the advertisement description information, and the advertisement content corresponding to the matched advertisement description information that are sent by the service server, and presents the advertisement content according to the matched version field in the advertisement description information when the service server provides an offline service.

13. An advertisement server, comprising:
a receiving module, configured to receive an advertisement request carrying advertisement request parameters;
an advertisement description library, configured to store advertisement contents and various versions of advertisement description information comprising a version field;
an advertisement selection module, configured to match the advertisement request parameters carried in the advertisement request that is received by the receiving module with the advertisement description information stored in the advertisement description library; and
a return module, configured to return the advertisement description information matched by the advertisement selection module, the matched version field in the advertisement description information, and the advertisement content corresponding to the matched advertisement description information to a service server or an advertisement client.

14. An advertisement client, comprising:
a request receiving module, configured to receive an advertisement request carrying advertisement request parameters that is sent by a service client;
an advertisement description library, configured to store advertisement contents and advertisement description information comprising a version field;
an advertisement selection module, configured to match the advertisement request parameters carried in the advertisement request that is received by the request receiving module with the advertisement description information stored in the advertisement description library; and
a content return module, configured to return the matched advertisement description information, the matched version field in the advertisement description information, and the advertisement content corresponding to the matched advertisement description information to the service client when the advertisement selection module selects the advertisement description information matching with the advertisement request parameters.

15. The advertisement client according to claim 14, further comprising:
a request sending module, configured to send the advertisement request to an advertisement server when the advertisement selection module does not obtain by selection the advertisement description information matching with the advertisement request parameters; and
a content receiving module, configured to receive matched advertisement description information, a matched version field in the advertisement description information, and an advertisement content corresponding to the matched advertisement description information that are returned by the advertisement server, store the matched advertisement description information and the advertisement content corresponding to the matched advertisement description information in the advertisement description library, and meanwhile notify the content return module of returning the matched advertisement description information, the matched version field in the advertisement description information, and the advertisement content corresponding to the matched advertisement description information to the service client.
